(19) United States
(12) Patent Application Publication
(10) Pub. No.: US 2009/0256897 A1
(43) Pub. Date: Oct. 15, 2009

(54) OBJECT HOLDER FOR PRINTING MULTIPLE IMAGES

(76) Inventors: Michael Lane Polk, Mint Hill, NC (US); Keith Hubert Copeland, Lancaster, SC (US)

Correspondence Address: ADAMS INTELLECTUAL PROPERTY LAW, P.A., Suite 2350 Charlotte Plaza, 201 South College Street, CHARLOTTE, NC, 28244, US

(21) Appl. No.: 12/439,069

(22) PCT Filed: Mar. 27, 2007
(86) PCT No.: PCT/US07/64975

§ 371 Date: Feb. 26, 2009

(51) Int. Cl. B41J 2/01; B41F 21/00; B41F 17/00

(52) U.S. Cl. 347/104; 101/407.1; 101/44

(57) ABSTRACT

An apparatus for printing an image on an object includes electronic image storage for storing the image and a print head positioned in spaced-apart relation to the object for receiving electronic data representing the image. The image is printed onto the object using an ink that is applied with a predetermined electrical charge polarity. A voltage generator generates an electrical charge having opposite polarity charge in relation to the predetermined charge polarity of the ink proximate the object and at a position to accelerate the ink being applied from the print head onto the object. A tray is provided for holding a plurality of the objects in a fixed orientation while the image is printed. The tray includes a plurality of cradles for receiving respective objects and a rotation assembly for rotating the cradles in unison to position a desired surface of the objects in proper orientation for printing.

### TECHNICAL FIELD AND BACKGROUND OF THE INVENTION

The present invention relates to the field of image printing systems. In particular, the invention relates to an object holder for holding a plurality of objects while an image is printed on flat, curved, spherical, regular and irregular substrates.

Currently, there are several devices available for receiving and holding a plurality of objects in a fixed orientation while an image is printed on a flat or irregular surface of each of the objects. However, these devices do not adequately satisfy the need to maintain the individual objects in registration with each other while printing on one or more of the objects and when moving the objects into position for printing. In addition, the known devices do not provide the ability to rotate a plurality of objects in unison to position each of the objects with a desired surface in the proper orientation for printing on flat, curved, spherical, regular and irregular surfaces.

Thus, it is desirable to provide an image printing system including an object holder that receives and holds a plurality of objects in a fixed orientation while an image is printed on a flat or irregular surface of the objects. It is further desirable to provide an image printing system including an object holder that rotates a plurality of objects in unison so that each of the objects is positioned with a desired surface in the proper orientation for printing an image on a flat, curved, spherical, regular or irregular surface of the object.

This application therefore describes an image printing system and a related method for printing multiple images that includes an object holder for receiving and holding a plurality of objects while the images are being printed on flat or irregular surfaces of the objects. The method allows a variance in distance between the ink jet head and substrate to occur during ink projection. Even droplet coverage occurs over flat or irregular surfaces as a result of the propagation of an electromagnetic field proximate the surface being printed with the surface being between the source of the electromagnetic field and the ink jet head. The image printing system and method eliminates or reduces satellite droplets by attracting a greater density of free airborne ink droplets to the substrate. These droplets may be diverted from their straight-line path by eddy air currents caused by the rapid movement of the ink jet head as it traverses rapidly back and forth during the printing process.

The object holder of the image printing system receives and holds a plurality of objects in a fixed orientation relative to one another while the distance between the ink jet head and the substrate varies during ink projection. The object holder maintains the individual objects in registration with each other while the images are printed. The object holder is configured to rotate the plurality of objects in unison to position a desired surface of the objects in proper orientation for printing images on the objects.

### SUMMARY OF THE INVENTION

Therefore it is an object of the invention to provide an image printing system that permits accurate, clear application of images on flat, curved, spherical, regular and irregular substrates.

It is another object of the invention to provide an image printing system including an object holder for holding at least one object in a fixed orientation while an image is printed on the object.

It is another object of the invention to provide an object holder comprising a tray adapted for receiving and holding a plurality of objects in a fixed orientation while an image is printed on each of the objects.

It is another object of the invention to provide a tray adapted for receiving and holding a plurality of objects that includes a plurality of individual cradles for receiving respective individual objects to be printed.

It is another object of the invention to provide a tray adapted for receiving and holding a plurality of objects that includes a plurality of individual cradles for receiving respective individual objects to be printed, and a rotation assembly cooperating with the cradles to rotate the cradles in unison for positioning a desired surface of the objects in proper orientation for printing.

These and other objects of the present invention are achieved in a preferred embodiment by providing an image printing system for printing an image on a plurality of objects that includes an object holder for holding at least one object while an image is printed on the object. The object holder comprises a tray adapted for receiving and holding a plurality of objects in a fixed orientation while an image is printed on each of the objects. The tray comprises a plurality of cradles for receiving objects to be printed, and a rotation assembly cooperating with the cradles to rotate the cradles in unison for positioning a desired surface in the proper orientation for printing.

According to another embodiment of the invention, each of the plurality of cradles receives a respective individual object and the cradle comprises a set of side supports on which the individual object rests and end supports to maintain the individual object in registration with at least one other individual object.

According to another embodiment of the invention, the end supports of each cradle are spring-loaded with sufficient force to maintain the individual objects in registration with each other.

According to another embodiment of the invention, the rotation assembly comprises means for manually rotating the cradles.

According to another embodiment of the invention, the means for manually rotating the cradles comprises a plurality of gears driven in unison by a drive gear.

According to another embodiment of the invention, the rotation assembly comprises a locking finger that fits into a notch formed in the drive gear to lock the objects in a desired orientation.

According to another embodiment of the invention, the rotation assembly comprises means for rotating the cradles selected from the group consisting of an electric motor and a pneumatic cylinder.

According to another embodiment of the invention, the image printing system includes an ink jet head using an ink that is applied with a predetermined electrical charge polarity and the tray is mounted on a high voltage plate connected to a voltage source for generating and applying an electrical charge having an opposite polarity charge in relation to the predetermined charge polarity of the ink proximate each of the objects.

These and other objects of the present invention are achieved in another preferred embodiment by providing a tray for use in an image printing system that is adapted for receiving and holding a plurality of objects in a fixed orientation while an image is printed on each of the objects. The tray comprises at least one cradle for receiving an individual object. The cradle comprises a set of side supports on which the individual object rests and end supports to maintain the individual object in registration with at least one other individual object while the image is printed on the object.

These and other objects of the present invention are achieved in yet another preferred embodiment by providing a tray for an image printing system that is adapted for receiving and holding a plurality of objects in a fixed orientation while an image is printed on each of the objects. The tray includes a plurality of cradles, each of the cradles receiving an individual object to be printed. The tray further includes a rotation assembly cooperating with the cradles to rotate the cradles in unison for positioning a desired surface of the object in the proper orientation for printing.

These and other objects of the present invention are achieved in yet another preferred embodiment by providing an image printing system for printing images on a plurality of objects. The image printing system includes an ink jet head adapted for using an ink that is applied to a substrate with a predetermined electrical charge polarity. The image printing system further includes a tray adapted for receiving and holding the plurality of objects in a fixed orientation while an image is printed on the objects. The tray comprises a plurality of cradles for receiving the objects to be printed, each of the cradles receiving an individual object to be printed, and a rotation assembly cooperating with the cradles to rotate the cradles in unison for positioning a desired surface in the proper orientation for printing.

### BRIEF DESCRIPTION OF THE DRAWINGS

The invention may be best understood by reference to the following description in conjunction with the accompanying drawing figures in which:

FIG. 1 shows an image printing system according to an embodiment of the invention;

FIG. 2 shows the image printing system of FIG. 1 printing on an ornament; and

FIGS. 3 through 9 are sequential perspective views of an image printing system, including one particular embodiment of a tray for holding an array of similar or identical objects to be printed.

### DESCRIPTION OF THE PREFERRED EMBODIMENTS AND BEST MODE

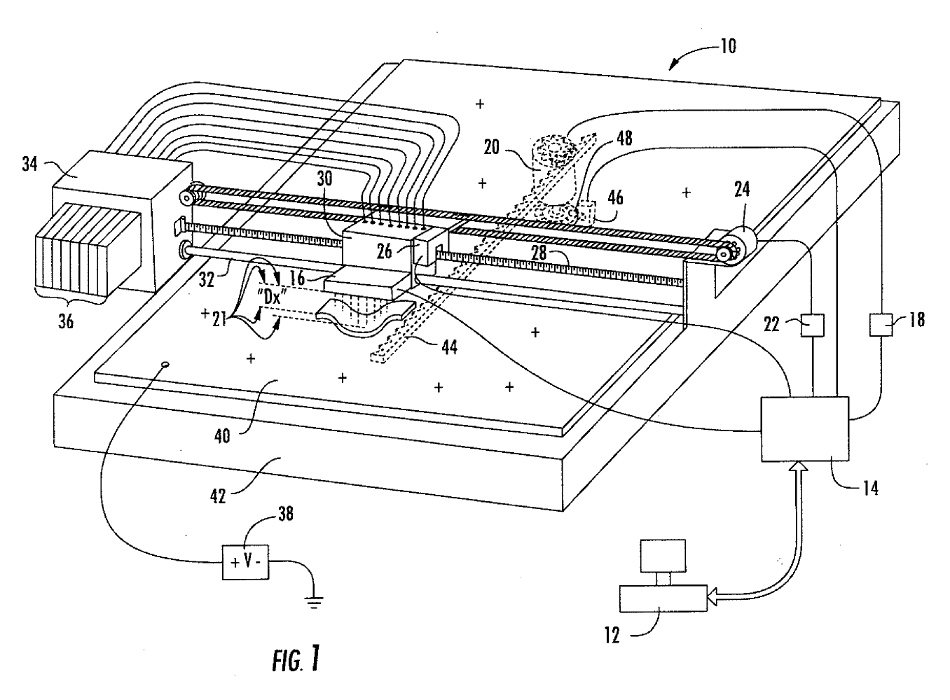

Referring now specifically to the drawings, an image printing system according to an embodiment of the invention is illustrated in FIG. 1 and shown generally at reference numeral 10. The system 10 includes a computer 12 having image rendering software connected to a printer control board 14. The printer control board 14 includes electronic hardware and firmware for interpreting instructions from the computer 12 to control an ink jet print head 16. The printer control board 14 also provides signals to a platen advance motor driver 18 to control a platen motor 20 and a carriage motor driver 22 to control a carriage motor 24.

A carriage encoder sensor 26 interacts with the printer control board 14 and a carriage encoder strip 28 to provide accurate indication of the location of a carriage assembly 30. The carriage assembly 30 is supported by a carriage support rail 32 and is driven by the carriage motor 24. The carriage assembly 30 includes ink dampeners, a print head 16, and ink cable connectors. in the embodiments disclosed in this application, the print head 16 is an ink-jet print head. However, any printing technology, including future developments that project fine ink droplets onto a printable substrate under the control of a computer is encompassed within this invention.

A bulk ink housing 34 is connected to the carriage assembly 30 and includes individual ink containers 36, collectively indicated, for supplying ink to the print head 16.

A high voltage source 38 is electrically connected to a high voltage plate 40 for providing a positively-charged electromagnetic field to a substrate. The high voltage plate 40 is supported by a platen support 42 and is moved by a platen advance mechanism 44 operably connected to the platen motor 20. A platen motor encoder sensor 46 is electrically connected to the printer control board 14, and operably connected to a platen motor encoder wheel 48 to determine the position of the platen support 42 and control the movements of the platen support 42 via the platen motor 20.

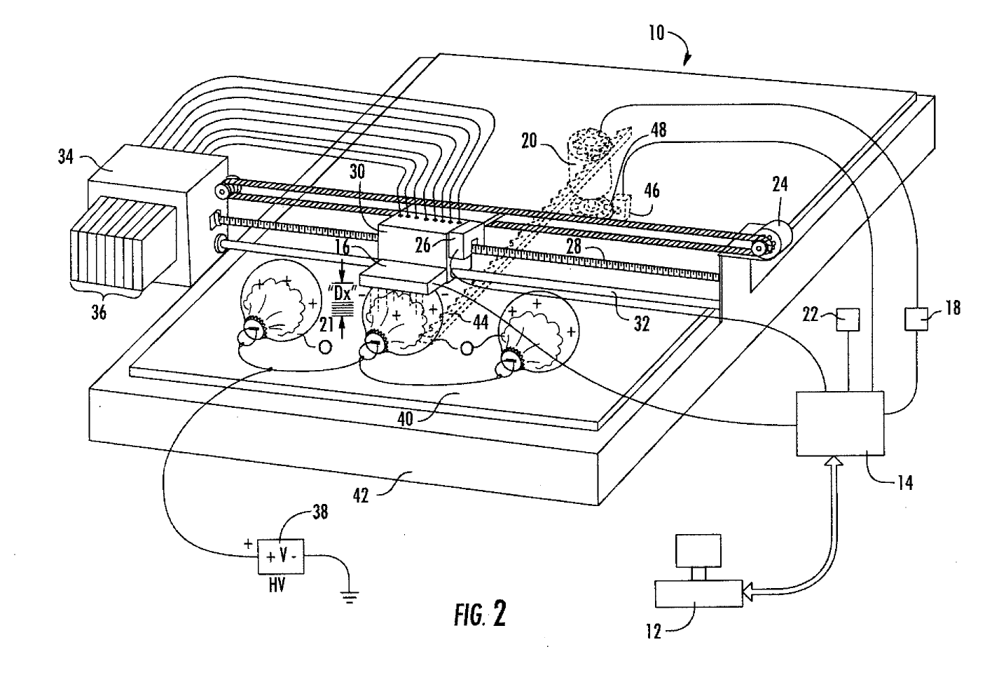

Referring now to FIG. 2, as droplets are ejected from the print head 16 toward the substrate, which may be the surface of any printable object, for example an ornament, that has an internal conductive coating, the in-flight droplet stream is negatively charged in its natural state as it leaves the print head 16. Each droplet is thus influenced by the positive high voltage charge from the high voltage plate 40.

Application of the positive field of the high voltage plate 40 to the substrate produces enhanced images due to the reduction of over-spray and satellite droplets that are effectively redirected for correct placement on the substrate of the ornament.

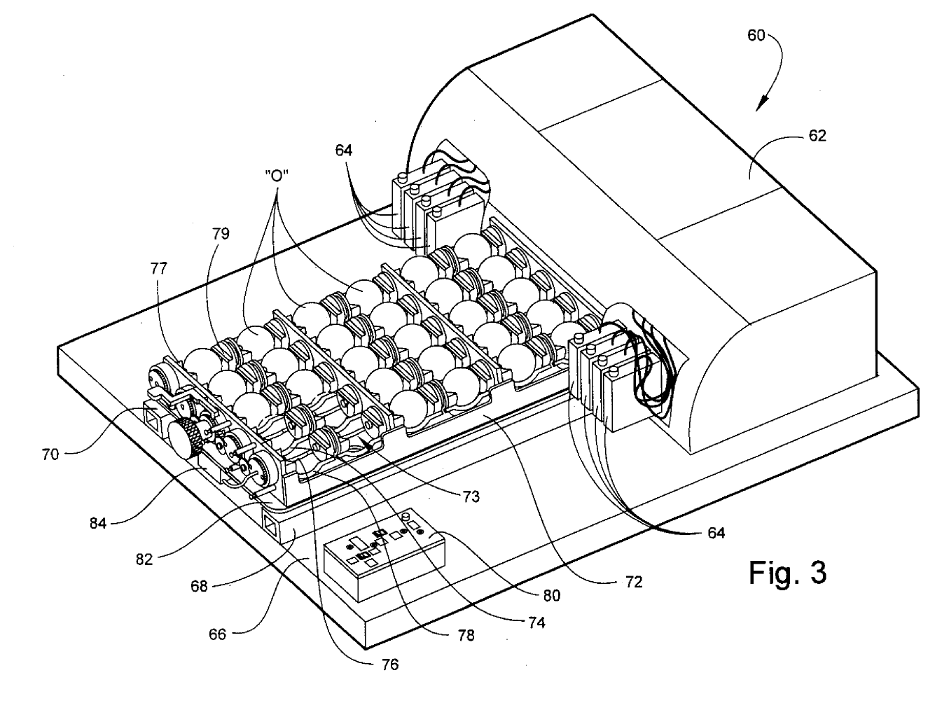

Referring now to FIGS. 3-9 a specific example is shown, where the method is carried out on a printer 60 to apply an image on circular Christmas ornaments “O” where the ornament(s) may be printed individually or batched, as shown. Printer 60 may be any suitable printer, including an ink-jet printer such as an Epson Model 1280 or 4800. In the description that follows, general reference may be made to FIGS. 1 and 2 as the operating elements of the printer 60 are described. Printer 60 includes a housing 62 that includes the printer elements such as described above with reference to FIGS. 1 and 2, controlled by a computer, such as computer 12. The computer 12 renders a desired digital image to the required size and color, or accesses digital images previously rendered, before transferring the image by means of control software that interfaces with the ink jet print head 16. In the particular embodiment shown in FIGS. 3-9, the ink supplies are positioned in ink containers 64, as shown.

The printer 60 is a flatbed printer and includes a base, or platen support, 66 on which the housing 62 is also mounted. A pair of parallel, spaced-part carriage support rails 68, 70 are mounted on the platen support 66 perpendicular to the side-to-side motion of the print head. A tray 72 is mounted on the carriage support rails 68,70 and is controlled in the manner described above whereby objects carried on the tray 72 are precisely positioned in relation to the print head to receive ink in a pattern controlled by the computer 12 and associated software. The tray 72 shown is exemplary of any suitable tray as would be designed and sized to accept particular objects to be printed.

Tray 72 is provided with 30 “nests” ordered in 5×6 rows to accept, in this particular illustrative embodiment, 30 glass ornaments “O”. The ornaments “O” are held in registration by individual cradles 73 (FIG. 3) formed of 30 sets of side supports 74, 76, 78 on which the ornaments “O” directly rest. The cradles are each spring-loaded with sufficient loading by end supports 77 and 79 to maintain the individual ornaments “O” in registration with each other. In particular embodiments, electrical conductivity may be established through each of the ornaments “O”, as described below. The printer 60 includes suitable controls contained on a control panel 80, such as shown in FIG. 3 and following. The tray 72 is mounted on a high voltage plate 82 connected to a voltage source 84.

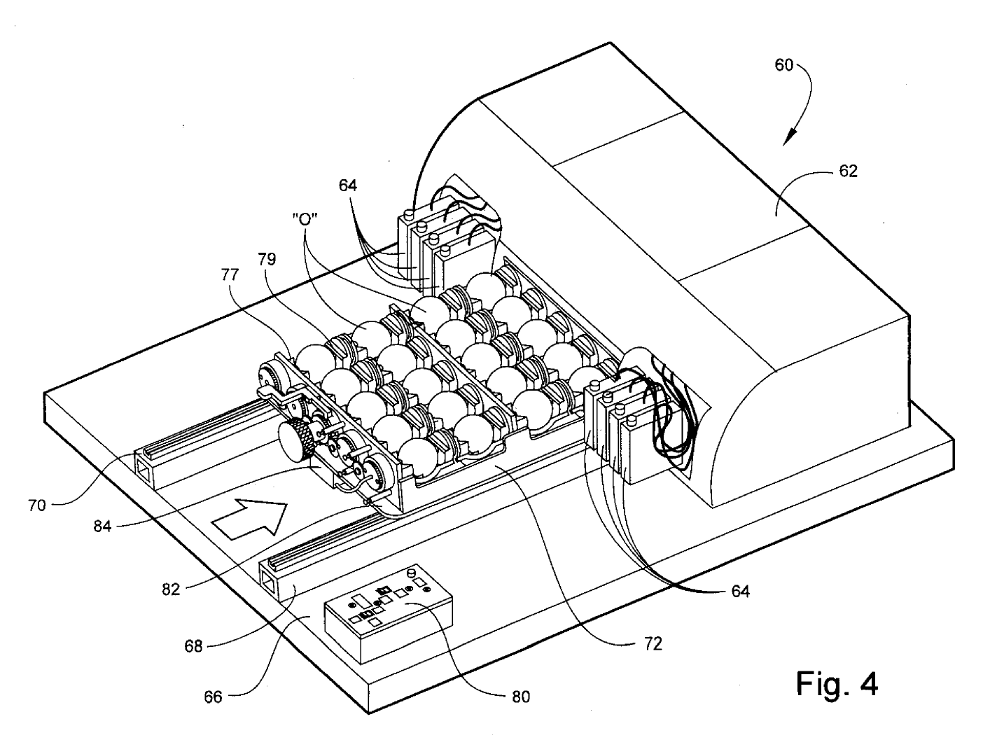

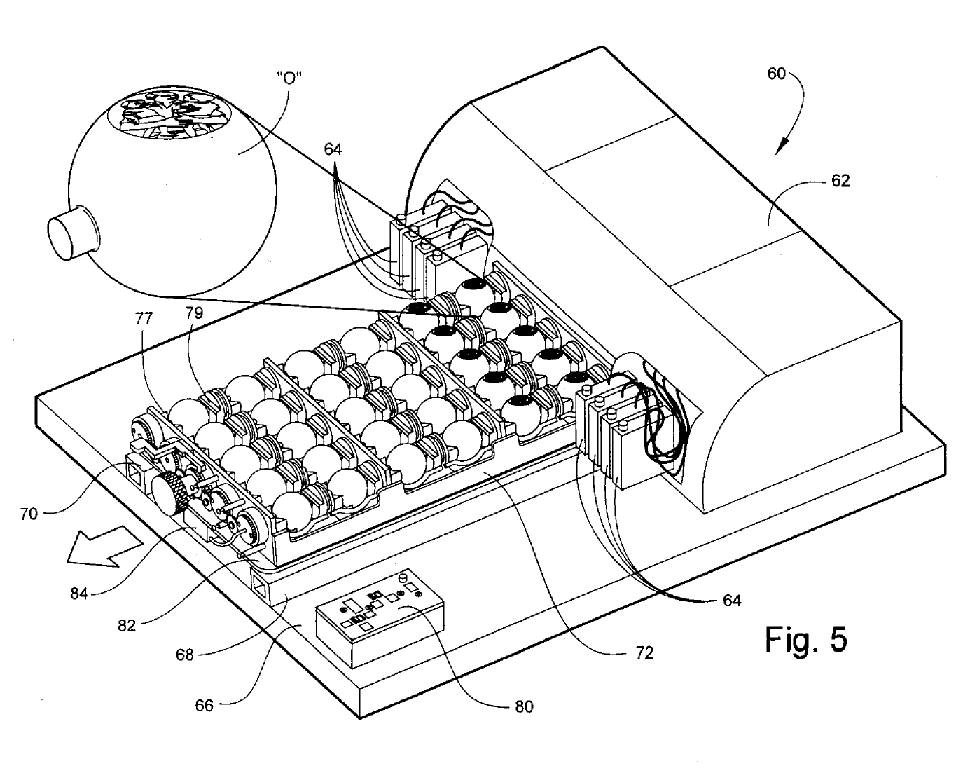

From the starting position shown in FIG. 3, the tray 72 is driven into the printer housing 62 under the control of the computer 12, as the print head is moved back-and-forth, ejecting a precisely-controlled spray of ink towards the surface of the ornaments “O”. The Ornaments “O” are printed on their top, curved surface. By way of example, as shown in FIGS. 4 and 5, two rows of Ornaments “O” are printed, but ordinarily the printing process would continue until all of the Ornaments “O” had been printed on the top-most surface directly below the print head. Alternatively, the tray 72 may be driven entirely into the printer housing 62 by the computer 12 and the rows of Ornaments “O” printed sequentially as the tray is retracted from the printer housing 62. The order in which the Ornaments “O” are printed is not critical and forms no part of the present invention. The tray 72 may be driven into the printer housing 62 in any suitable manner and the Ornaments “O” may be printed in any desired order as long as the tray holds a plurality of articles for printing and at least one article is made available to the print head for printing.

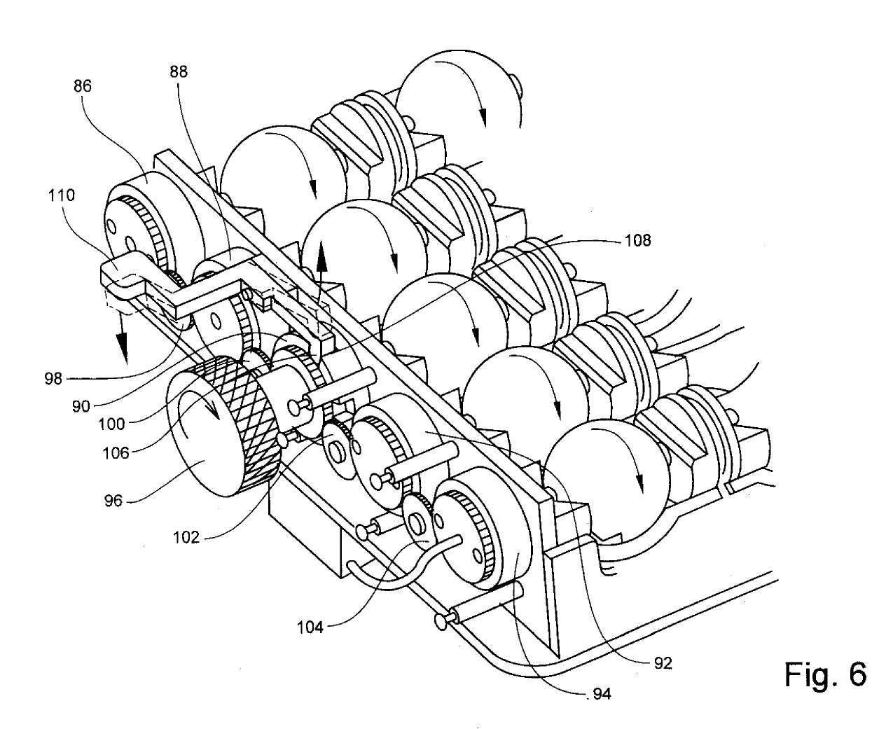

Referring now to FIG. 6, a manual means of rotating the Ornaments “O” for printing on another surface is shown. Each of the 5 rows of Ornaments “O” are mounted for unison rotation on the cradle elements, including the side supports 74, 76, 78 (FIG. 3) and end supports 77 and 79 (FIG. 3).

Each row is driven by respective gears 86, 88, 90, 92 and 94. These gears are driven in unison by a drive gear 96 that directly rotates gear 90 and rotates gears 86, 88, 92 and 94 through intermediate gears 98, 100, 102 and 104. While this particular embodiment is manually-rotated, it is envisioned that commercial units will be rotated automatically by an electric motor, pneumatic cylinder or other suitable means. The Ornaments “O” are locked in a desired orientation by a locking finger 106 that fits into a notch 108 in the gear 90. The locking finger is controlled by a lever 110.

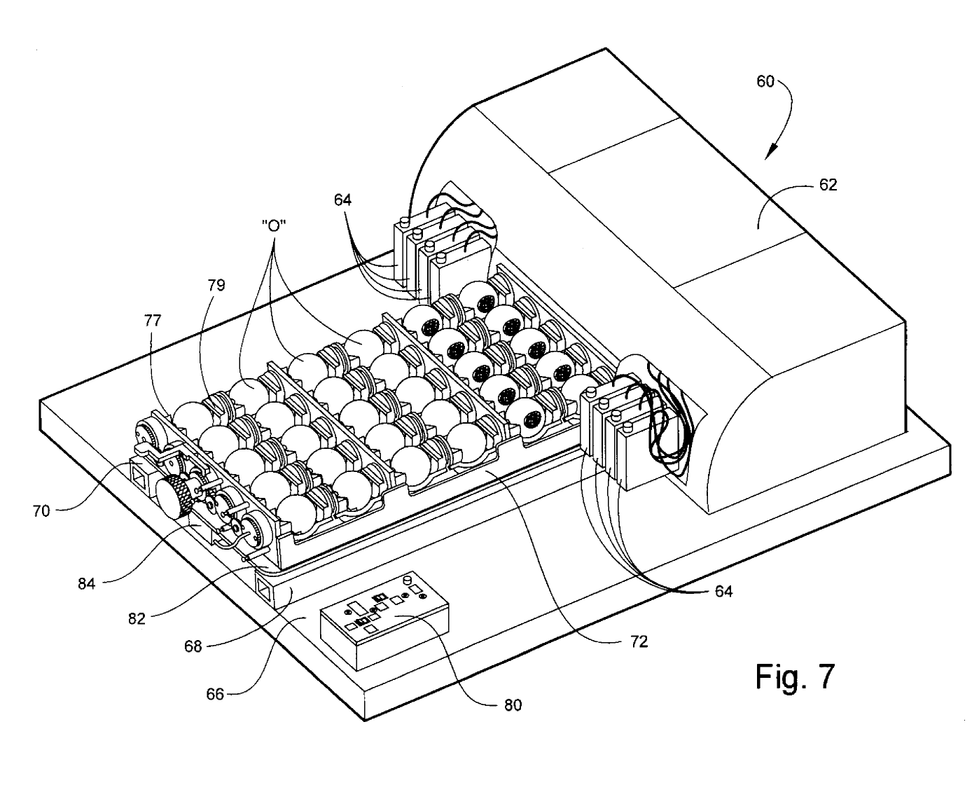

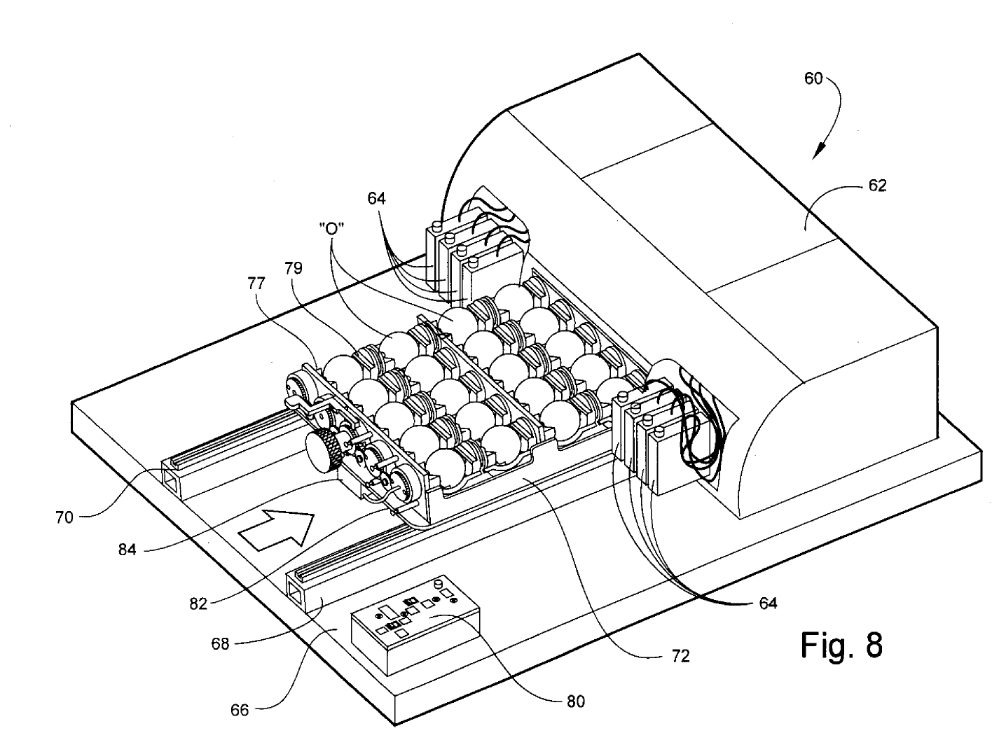

Referring now to FIG. 7, the Ornaments “O” have been rotated clockwise 90 degrees and, as shown in FIG. 8, the tray 72 is again moved into the housing 62 and a second side of each of the Ornaments “O” is printed.

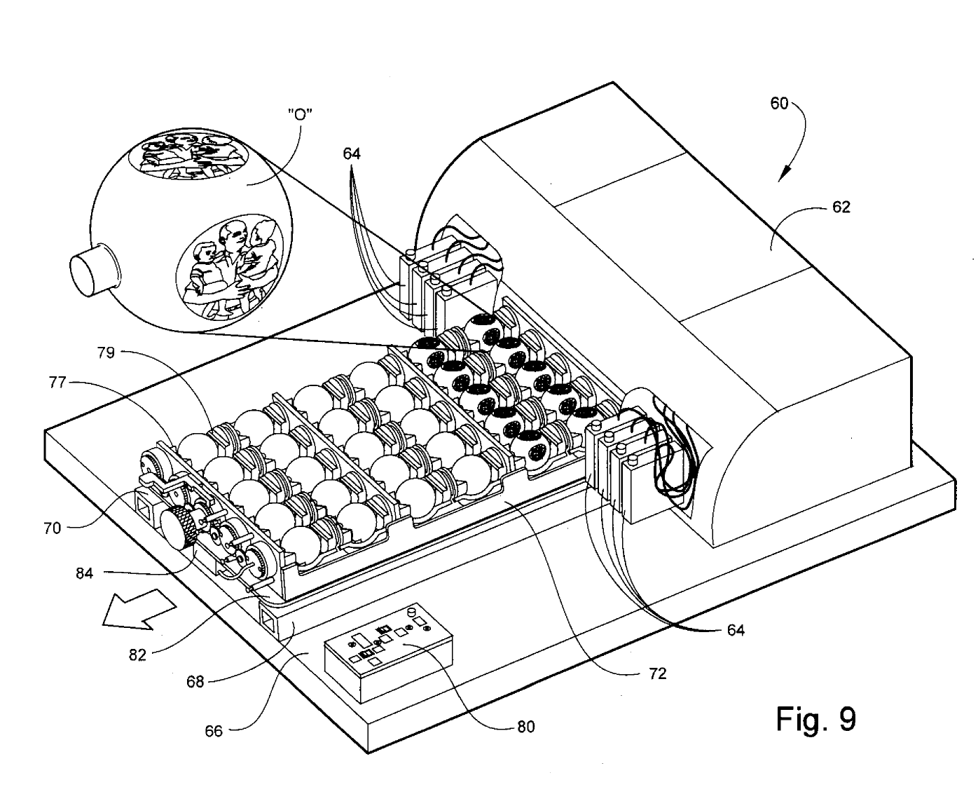

As is shown in FIG. 9, two sides of the first two rows of Ornaments “O” have been printed. The method can be repeated to place images on a third side or on all four sides, as desired.

The apparatus and method as described above may be applied in several ways.

First, the electromagnetic field may be generated beneath the ornament “O” or other object to be printed. The field, which may be between 2000 and 3000 Volts at a very low current on the order of 500 nano-amps or less, is sufficient to overcome the effects of air currents generated by rapid movement of the print head 16 and associated mechanical parts, and allows the inertia of the ink droplets to maintain straight line flight directly onto the ornament “O” by attraction of the negatively-charged high voltage plate 82. Of course, this value will vary depending on the particular circumstances but would ordinarily be less than a milliamp. This would also be suitable when printing on objects that are not electrically conductive, such as objects made of plastics, rubber, resins, and the like.

Second, the electromagnetic field may be propagated in the object itself if the object is electrically conductive or has applied to it an electrically-conductive coating. For example, a hollow glass ornament, such as a Christmas tree ornament, may be rendered electrically conductive by coating the interior of the glass with an electrically-conductive coating such as silver. Current flow is achieved though contact between the current source and, for example, a metal cap inserted into the ornament, such as used to suspend the ornament during use. The charge applied to the ornament “O” is therefore only a very short distance from the print head, and a very accurate, non-dispersed image can be created.

Third, in appropriate circumstances an electromagnetic charge can be induced through an electrically non-conductive material into an electrically conductive layer on the other side of the electrically non-conductive material. In the case of the glass ornament “O”, for example, the silver inner coating can be charged through the adjacent glass surface by charging the plate 82 beneath the tray 72, thereby avoiding the need to provide current leads to each of the ornaments “O”.

In any of the options described above, the direction of in-flight ink droplets is controlled toward the desired registration on the ornaments “0” due to the orientation of the field. By varying the strength of the electromagnetic field the acceleration of the ink-jet droplets may be controlled to achieve the desired results.

The increased bonding of ink droplets to the ornaments “O” is due to the increased electrical potential between the predetermined charge polarity (e.g. negative or positive) of the applied ink and the opposite polarity charge (e.g. positive or negative) of the inner surface of the ornament. Increasing the velocity of the droplets of applied ink solution also increases bonding of the ink to the ornaments “O”, and the ‘dot gain’ increases as a result of the higher kinetic energy in each droplet as it hits the surface. This method reduces ‘banding’ effects that plague ink jet printing processes; eliminates noticeable lines in the image and creates a contiguous look in the final printed image.

Droplets are typically on the order 3 to 17 Pico-liters in-flight and can be controlled and accelerated by the application of directive control fields.

By controlling the in-flight droplets using the application of an electromagnetic field, a higher number of droplets will hit the substrate with higher accuracy and not be affected by other forces created by the mechanical assemblies advancing the substrate or assemblies moving the ink jet head. These physical movements create undesired forces, such as air currents and stray electrostatic charges, that act on the ink droplets and misdirect ink droplets creating ‘satellite droplets’ that stray from their intended target. The result is noticeable blurred images and “over spray” outside the image border.

Eliminating satellite droplets and directing those droplets to their intended targets increases image resolution and density, thus increasing the total droplets of ink in the image. Controlling the in-flight droplets by the application of an electromagnetic field allows higher printing accuracy at faster print speeds, which increases productivity and printer output. The substrate advance and ink propulsion from the head can both be increased in time while achieving quality image resolution on both irregular and flat surfaces. Using this method eliminates over-spray, loss of color density, and loss of resolution. These are problems that are most noticeable when printing an image onto an irregular surface.

Eliminating satellite droplets also reduces harmful contaminates that become airborne during manufacturing processes involving ink jetting of various ink solutions. This system may also be used to meet certain safety regulations concerning MSDS contents identifying harmful chemicals and reducing inhalant content.

The application of force used to control ‘in-flight droplets’ can include of one or more of the following: voltage fields, magnetic fields, pressure fields i.e.; acoustic or pressure waves, and/or optical electromagnetic energy.

The above example is merely illustrative, and other substrates that are spherical curved, or round in shape including but not limited to glass, tile and ceramic eggs or heart shaped ornaments, may be printed as described above, as well as flat substrates such as glass, tile or ceramic ornaments. Specific objects which can be printed as described above include round, spherical or curved objects such as sporting balls including but not limited to baseballs, golf balls, footballs, basketballs, softballs or soccer balls, paper, Mylar, cardboard, overlays, stickers and the like, or rigid substrates such as glass, tile, ceramics, wood, plastic, hardboard, and the like, as well as textile materials such as fabrics used in t-shirts and other clothing, hats, footwear, or other apparel.

An image printing apparatus and method is described above. Various details of the invention may be changed without departing from the scope of the invention. Furthermore, the foregoing description of the preferred embodiment of the invention and best mode for practicing the invention are provided for the purpose of illustration only and not for the purpose of limitation, the invention being defined by the claims.

What is claimed is:

1. An object holder for an image printing system, the object holder comprising:
a tray adapted for receiving and holding a plurality of objects in a fixed orientation while an image is printed on each of the objects, the tray comprising a plurality of cradles for receiving objects to be printed and a rotation assembly cooperating with the cradles to rotate the cradles in unison to position a desired surface in the proper orientation for printing.

2. An object holder according to claim 1, wherein each of the plurality of cradles receives a respective individual object and wherein the cradle comprises a set of side supports on which the individual object rests and end supports to maintain the individual object in registration with at least one other individual object.

3. An object holder according to claim 2, wherein the end supports are spring-loaded with sufficient force to maintain the individual objects in registration with each other.

4. An object holder according to claim 1, wherein the rotation assembly comprises means for manually rotating the cradles.

5. An object holder according to claim 4, wherein the means for manually rotating the cradles comprises a plurality of gears driven in unison by a drive gear.

6. An object holder according to claim 5, wherein the rotation assembly comprises a locking finger that fits into a notch formed in the drive gear to lock the objects in a desired orientation.

7. An object holder according to claim 1, wherein the rotation assembly comprises means for rotating the cradles selected from the group consisting of an electric motor and a pneumatic cylinder.

8. An object holder according to claim 1, wherein the image printing system comprises an ink jet head using an ink that is applied with a predetermined electrical charge polarity and wherein the tray is mounted on a high voltage plate connected to a voltage source for generating and applying an electrical charge having an opposite polarity charge in relation to the predetermined charge polarity of the ink proximate each of the objects.

9. A tray for an image printing system adapted for receiving and holding a plurality of objects in a fixed orientation while an image is printed on each of the objects, the tray comprising:
at least one cradle for receiving an individual object, the cradle comprising a set of side supports on which the individual object rests and end supports to maintain the individual object in registration with at least one other individual object while the image is printed on the object.

10. A tray according to claim 9, wherein the end supports are spring-loaded with sufficient force to maintain the individual objects in registration with each other.

11. A tray according to claim 9, wherein the image printing system comprises an ink jet head using an ink that is applied with a predetermined electrical charge polarity and wherein the tray is mounted on a high voltage plate connected to a voltage source for generating and applying an electrical charge having an opposite polarity charge in relation to the predetermined charge polarity of the ink proximate each of the objects.

12. A tray for an image printing system adapted for receiving and holding a plurality of objects in a fixed orientation while an image is printed on each of the objects, the tray comprising:
a plurality of cradles, each of the cradles receiving an individual object to be printed; and
a rotation assembly cooperating with the cradles to rotate the cradles in unison for positioning a desired surface of the object in the proper orientation for printing.

13. A tray according to claim 12, wherein the rotation assembly comprises means for manually rotating the cradles.

14. A tray according to claim 13, wherein the means for manually rotating the cradles comprises a plurality of gears driven in unison by a drive gear.

15. A tray according to claim 14, wherein the rotation assembly comprises a locking finger that fits into a notch formed in the drive gear to lock the objects in a desired orientation.

16. A tray according to claim 12, wherein the rotation assembly comprises means for rotating the cradles selected from the group consisting of an electric motor and a pneumatic cylinder.

17. A tray according to claim 12, wherein the image printing system comprises an ink jet head using an ink that is applied with a predetermined electrical charge polarity and wherein the tray is mounted on a high voltage plate connected to a voltage source for generating and applying an electrical charge having an opposite polarity charge in relation to the predetermined charge polarity of the ink proximate each of the objects.

18. An image printing system for printing images on a plurality of objects comprising:
an ink jet head adapted for using an ink that is applied to a substrate with a predetermined electrical charge polarity; and
a tray adapted for receiving and holding the plurality of objects in a fixed orientation while an image is printed on the objects, the tray comprising
a plurality of cradles for receiving the objects to be printed, each of the cradles receiving an individual object to be printed; and
a rotation assembly cooperating with the cradles to rotate the cradles in unison for positioning a desired surface in the proper orientation for printing.

19. An image printing system according to claim 18, wherein each of the plurality of cradles comprises a set of side supports on which the individual object rests and end supports to maintain the individual object in registration with at least one other individual object and wherein the rotation assembly comprises a plurality of gears driven in unison by a drive gear.

20. An image printing system according to claim 18, wherein the tray is mounted on a high voltage plate connected to a voltage source for generating and applying an electrical charge having an opposite polarity charge in relation to the predetermined charge polarity of the ink proximate each of the objects.
